(19) United States
(12) Patent Application Publication
(10) Pub. No.: US 2012/0069594 A1
(43) Pub. Date: Mar. 22, 2012

(54) INTERNAL LIGHTING DISPLAY DEVICE AND DISPLAY PANEL THEREOF

(75) Inventors: Shingo Nomura, Tokyo (JP); Kensuke Mizobuchi, Tokyo (JP); Hideyuki Ikeda, Tokyo (JP); Kouji Kumada, Tokyo (JP); Kouji Katsura, Tokyo (JP); Yoichi Shibata, Tokyo (JP); Hideo Yoshida, Tokyo (JP); Yoichiro Shiozaki, Tokyo (JP)

(73) Assignee: FURUKAWA ELECTRIC CO., LTD., Tokyo (JP)

(21) Appl. No.: 13/139,376

(22) PCT Filed: Dec. 9, 2009
(86) PCT No.: PCT/JP2009/070593

§ 371 Date: Nov. 29, 2011

(30) Foreign Application Priority Data
Dec. 12, 2008 (JP) 2008-316829

(51) Int. Cl. B60Q 1/00; F21V 7/22; G09F 13/04; F21V 7/00

(52) U.S. Cl. 362/516; 362/296.01; 362/296.02; 40/564

(57) ABSTRACT

An interior lighting display device and a display panel thereof capable of effectively preventing a dark area from being formed in the display panel. A film or sheet that reflects light is disposed on a back surface and a side surface of a display panel of an interior lighting display device. For example, the film or sheet is disposed on a back surface and a side surface of a region that is a colored area having low transmittance of the display panel, and an area in which a light source is not present behind the display panel. In addition, a light reflective body is placed in an area in which the light source is not present within the interior lighting display device.

### TECHNICAL FIELD

The present invention relates to an internal lighting display device in which an opening section of a frame-shaped or a box-shaped housing is closed by a display panel having translucency and a light source is installed within the housing, and a display panel used in the internal lighting display device.

### BACKGROUND ART

In the past, an internal lighting signboard including a box-shaped housing with an open front surface, a display panel that closes the opening section of the box-shaped housing, and a light source installed within the box-shaped housing has been proposed (refer to, for example, Patent Literature 1). In the internal lighting signboard in Patent Literature 1, an elongated light source is provided within the box-shaped housing, and a display panel having translucency and used for advertisement is provided on the front side of the box-shaped housing. In the signboard in which the display panel is illuminated by the light from the light source, a reflective body is provided within the box-shaped housing.

Furthermore, in the past, an internal lighting vehicle display device has been proposed that includes a box-shaped housing with an open front surface, a display panel that closes the opening section of the box-shaped housing, and a light source installed in the box-shaped housing (refer to, for example, Patent Literature 2). The vehicle display device in Patent Literature 2 is erected in an instrument panel of a vehicle, and includes a display panel in which a design is formed for analog display in which indication is performed by an indicator needle that is rotated by movement. The display panel is formed by a dial that is integrated with a backlight.

### PATENT LITERATURE

Patent Literature 1: Japanese Patent Laid-open Publication No. 2000-148051
Patent Literature 2: Japanese Patent Laid-open Publication No. 2004-69514

### DISCLOSURE OF INVENTION

### Problem to be Solved by the Invention

In the display panel of the internal lighting signboard of Patent Literature 1, when a large amount of color having low transmittance is used as the color for forming the display panel, particularly when a color having low transmittance is used as a ground color, and text and designs for advertisement are displayed uncolored or using a color having high transmittance within the ground color, a problem occurs in that the light from the light source is absorbed by the area of the color having low transmittance, and the text and designs formed using the color having high transmittance become dark. In particular, in a two-sided signboard having a display panel on both sides, the text and designs become even darker because a reflective plate cannot be provided.

In addition, when the light source is reduced in adherence to the recent demands for energy conservation, the above-described tendency becomes more noticeable. In other words, conventionally, as shown in FIG. 1 of Patent Literature 1, a straight-type fluorescent tube of almost the same length as the box-shaped housing in a longitudinal direction of the signboard is included as the light source. When the signboard is long, for example, a fluorescent tube of 40 W and a fluorescent tube of 20 W are installed continuously in the longitudinal direction. However, when the number of fluorescent tubes is reduced and an area in which the fluorescent tube is not present is present in both end sections in the longitudinal direction of the box-shaped housing, if a large amount of color having low transmittance is used in an area facing the area in which the fluorescent tube is not present in the display panel, a problem occurs in that the area becomes extremely dark.

In the display panel of the internal lighting vehicle display device of Patent Literature 2, when a large amount of color having low transmittance is used as the color for forming the display panel, particularly when a color having low transmittance is used as a ground color, and text and designs for display are displayed uncolored or using a color having high transmittance within the ground color, a problem occurs in that the light from the light source is absorbed by the area of the color having low transmittance, and the text and designs formed using the color having high transmittance become dark.

In addition, the internal lighting vehicle display device of Patent Literature 2 requires a large number of point-shaped light sources (light emitting diode [LED]) as the light source. However, when the number of point-shaped light sources is reduced, if a large amount of color having low transmittance is used in the areas facing the areas in which the point-shaped light sources are not present in the display panel, a problem occurs in that the areas become extremely dark.

Furthermore, in the internal lighting vehicle display device of Patent Literature 2, because a display panel that is integrated with a backlight is used, a problem occurs in that the display panel becomes heavy.

The present invention has been achieved in light of the above-described issues. An object of the present invention is to provide an internal lighting display device and a display panel thereof capable of effectively preventing a dark area from being formed in the display panel.

### Means for Solving Problem

To achieve the above-described object, the present invention provides a display panel (1) to (9) and an interior lighting display device (10) to (27), described below.

(1) A display panel of an interior lighting display device including a frame-shaped housing having an opening section on both surfaces, the display panel that closes both opening sections of the frame-shaped housing, and a light source installed within the frame-shaped housing, in which a film or sheet that reflects light is disposed on a portion or an entirety of a back surface, a side surface, or both.

(2) A display panel of an interior lighting display device including a box-shaped housing having an opening section on one surface, the display panel that closes the opening section of the box-shaped housing, and a light source installed within the box-shaped housing, in which a film or sheet that reflects light is disposed on a portion or an entirety of a back surface, a side surface, or both.

(3) The display panel (1) or (2) in which the interior lighting display device is an interior lighting signboard.

(4) The display panel (2) in which the interior lighting display device is a vehicle display device installed in front of a driver's seat of a vehicle, and the display panel is a display panel displaying vehicle information, such as speed of the vehicle, engine speed, and fuel capacity.

(5) The display panel (1) to (4) in which the film or sheet that reflects light is disposed on a portion or an entirety of a back surface, a side surface, or both, of a colored area having low transmittance of the display panel.

(6) The display panel (1) to (5) in which the film or sheet that reflects light is disposed on a portion or an entirety of a back surface, a side surface, or both, of an area in which the light source is not present behind the display panel.

(7) The display panel (4) to (6) in which the film or sheet that reflects light is disposed on a portion or an entirety of a back surface, a side surface, or both, of an area in which the vehicle information is not displayed of the display panel.

(8) The display panel (1) to (7) in which the film or sheet that reflects light is a thermoplastic resin film or sheet having fine bubbles or pores therewithin with a mean bubble diameter of 50 nm or more and 50 μm or less.

(9) The display panel (1) to (7) in which the film or sheet that reflects light is a thermoplastic resin film or sheet containing fillers, and is a film or sheet in which numerous voids are formed with the fillers serving as cores.

(10) An interior lighting display device including a frame-shaped housing having an opening section on both surfaces, a display panel that closes both opening sections of the frame-shaped housing, and a light source installed within the frame-shaped housing, in which a film or sheet that reflects light is disposed on a portion or an entirety of a back surface, a side surface, or both, of the display panel.

(11) An interior lighting display device including a box-shaped housing having an opening section on one surface, a display panel that closes the opening section of the box-shaped housing, and a light source installed within the box-shaped housing, in which a film or sheet that reflects light is disposed on a portion or an entirety of a back surface, a side surface, or both, of a display panel.

(12) The interior lighting display device (10) or (11) in which the interior lighting display device is an interior lighting signboard.

(13) The interior lighting display device (11) in which the interior lighting display device is a vehicle display device installed in front of a driver's seat of a vehicle, and the display panel is a display panel displaying vehicle information, such as speed of the vehicle, engine speed, and fuel capacity.

(14) The interior lighting display device (11) to (13) in which a film or sheet that reflects light is disposed on a portion or an entirety of a back surface opposing the display panel of the box-shaped housing.

(15) The interior lighting display device (10) to (14) in which the film or sheet that reflects light is disposed on a portion or an entirety of a back surface, a side surface, or both, of a colored area having low transmittance of the display panel.

(16) The interior lighting display device (10) to (15) in which the film or sheet that reflects light is disposed on a portion or an entirety of a back surface, a side surface, or both, of an area in which the light source is not present behind the display panel.

(17) The interior lighting display device (13) to (16) in which the film or sheet that reflects light is disposed on a portion or an entirety of a back surface, a side surface, or both, of an area in which the vehicle information is not displayed of the display panel.

(18) The interior lighting display device (10) to (17) in which the film or sheet that reflects light is a thermoplastic resin film or sheet having fine bubbles or pores therewithin with a mean bubble diameter of 50 nm or more and 50 μm or less.

(19) The interior lighting display device (10) to (17) in which the film or sheet that reflects light is a thermoplastic resin film or sheet containing fillers, and is a film or sheet in which numerous voids are formed with the fillers serving as cores.

(20) An interior lighting display device including a frame-shaped housing having an opening section on both surfaces, a display panel that closes both opening sections of the frame-shaped housing, and a light source installed within the frame-shaped housing, in which a light reflective body is disposed in an area in which the light source is not present within the frame-shaped housing.

(21) An interior lighting display device including a box-shaped housing having an opening section on one surface, a display panel that closes the opening section of the box-shaped housing, and a light source installed within the box-shaped housing, in which a light reflective body is disposed in an area in which the light source is not present within the box-shaped housing.

(22) The interior lighting display device (20) or (21) in which the light reflective body is peak-shaped, and has a tapered section that becomes closer to the display panel, the farther away from the light source the light reflective body is.

(23) The interior lighting display device (20) or (21) in which the light reflective body is peak-shaped, and has a curved surface that becomes closer to the display panel, the farther away from the light source the light reflective body is.

(24) The interior lighting display device (20) to (23) in which the light reflective body is formed by a film or sheet that reflects light.

(25) The interior lighting display device (24) in which the film or sheet that reflects light is a thermoplastic resin film or sheet having fine bubbles or pores therewithin with a mean bubble diameter of 50 nm or more and 50 μm or less.

(26) The interior lighting display device (24) in which the film or sheet that reflects light is a thermoplastic resin film or sheet containing fillers, and is a film or sheet in which numerous voids are formed with the fillers serving as cores.

(27) The interior lighting display device (20) to (26) in which the display panel is a display panel (1) to (9).

In the display panels (1) to (9) and the interior lighting display devices (10) to (19) and (27), light is reflected by the film or sheet adhered to the back surface or the side surface of the display panel. Therefore, when the film or sheet is adhered to the back surface or the side surface of a colored area having low transmittance of the display panel, light is reflected without being absorbed by the area having low transmittance, reflected within the housing, and emitted from the area of a color having high transmittance. Therefore, text and designs displayed in color having high transmittance become bright. In addition, when the film or sheet is adhered to the back surface or the side surface of the area in which the light source is not present behind the display panel, because light is reflected by the film or sheet, the area in which the light source is not present within the housing becomes bright. Furthermore, in the interior lighting display devices (20) to (26), because light is reflected by the light reflective body placed in the area in which the light source is not present within the housing, the area in which the light source is not present within the housing becomes bright.

Therefore, according to the present invention, as described above, a problem can be particularly effectively solved, the problem being, when fluorescent tubes are reduced and an area in which a fluorescent tube is not present is present in both end sections in a longitudinal direction of a housing in an interior lighting signboard, or when the number of point-shaped light sources are reduced and an area in which the point-shaped light source is not present is present within a housing in an interior lighting vehicle display device, if a large amount of color having low transmittance is used in an area facing an area in which the fluorescent tube or the point-shaped light source is not present of the display panel, the area becomes extremely dark.

### Effect of the Invention

In the internal lighting display device and the display panel of the present invention, a dark area can be effectively prevented from being formed in the display panel.

### BRIEF DESCRIPTION OF DRAWINGS

FIG. 1 is a schematic perspective view of an internal lighting signboard according to an embodiment of an internal lighting display device of the present invention;

FIG. 2 is a schematic front view of the internal lighting signboard in FIG. 1;

FIG. 3 is a schematic cross-sectional view of the internal lighting signboard in FIG. 1;

FIG. 4 is a partial rear view of a display panel used in the internal lighting signboard in FIG. 1;

FIG. 5 is a side view of an example of a reflective body;

FIG. 6 is a schematic front view of an internal lighting vehicle display device according to an embodiment of the internal lighting display device of the present invention;

FIG. 7 is a schematic cross-sectional view taken along line A-A in FIG. 6; and

FIG. 8 is a perspective view of a box composed of a film or a sheet that reflects light used to manufacture the internal lighting vehicle display device in FIG. 6.

### BEST MODE(S) FOR CARRYING OUT THE INVENTION

The present invention will hereinafter be described according to embodiments shown in the drawings. However, the present invention is not limited to the examples described below.

### First Embodiment

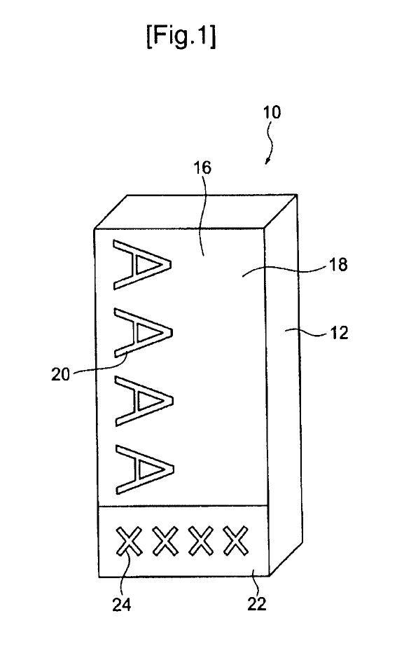

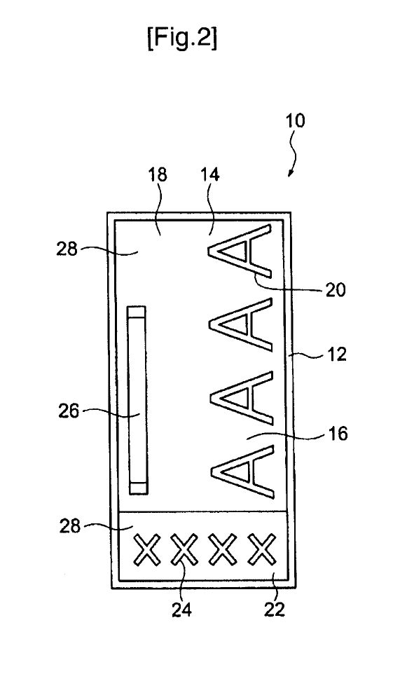

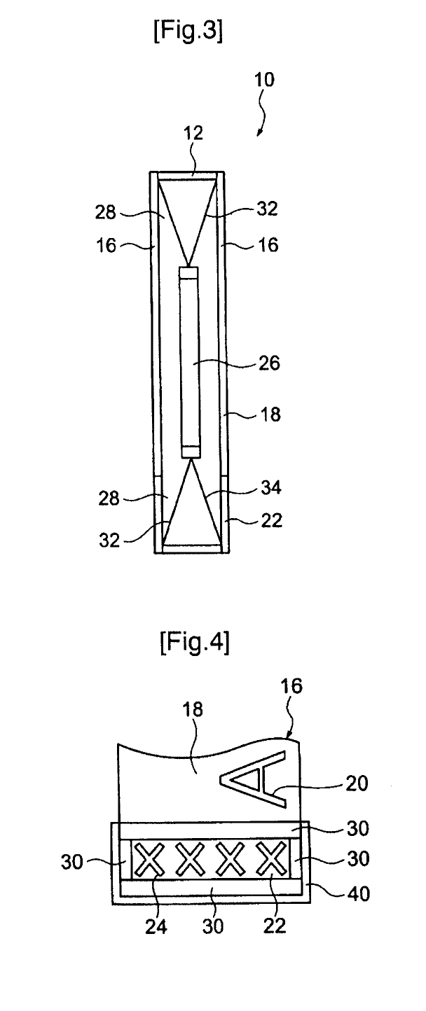

FIG. 1 to FIG. 3 show an internal lighting signboard according to an embodiment of an internal lighting display device of the present invention. FIG. 1 is a schematic perspective view. FIG. 2 is a schematic front view in a state in which a display panel and a light reflective body (both described hereafter) on a front surface side are omitted. FIG. 3 is a schematic cross-sectional view.

In an internal lighting signboard 10 according to the present embodiment, reference number 12 indicates a rectangular frame (frame-shaped housing) with an elongated cross-section, having an opening section 14 on both surfaces. The frame 12 is formed by a metal, such as aluminum, an aluminum alloy, or stainless steel.

Both opening sections 14 of the frame 12 are closed by a display panel 16. The display panel 16 is composed of a synthetic resin board having translucency, such as an acrylic resin, a flexible face (FF) sheet, or polycarbonate. In the present example, text (AAAA) 20 for advertisement is displayed in white in a region 18 that is roughly the upper four-fifths of the display panel 16. Areas other than the text 20 of the region 18 are colored blue. Text (XXXX) 24 for advertisement is displayed in white in a region 22 that is roughly the lower one-fifth of the display section 16. The areas other than the text 24 in the region 22 are colored dark brown. The above-described text and ground colors are formed by printing, such as silk-screen printing. The coloring method is not limited to printing and, for example, a sheet on which text or a design is formed may be adhered.

Within the frame 12, a straight-type fluorescent tube 26 is installed as a light source. In the present example, to reduce the light source, a single fluorescent tube 26 that is shorter than the vertical length of the frame 12 is disposed in an intermediate portion in a vertical direction of the frame 12. Therefore, an area 28 in which the fluorescent tube 26 is not present is present in both end sections in the vertical direction within the frame 12. In the present example, the fluorescent tube 26 is disposed on one end side in a horizontal direction of the frame 12. This is because, when the fluorescent tube is disposed in a center portion in the horizontal direction of the frame 12, a metal holding member (not shown) that holds the fluorescent tube causes the holding member side to become dark.

In the present example, the lower region 22 is colored a dark brown and is an area having low transmittance. Because the text 24 is displayed in the region 22 in white that is a color having high transmittance, the light from the fluorescent tube 26 is absorbed by the dark brown area, and the text 24 becomes dark. In particular, in the present example, because the area 28 in which the fluorescent tube 26 is not present is present in both end sections in the vertical direction within the frame 12, the text 24 becomes extremely dark.

Here, the area that is colored and has low transmittance refers to an area having a transmittance of 10% or lower. The transmittance takes into consideration the applied color and the material of the display panel 16. When a sheet on which text or a design is formed is disposed, the transmittance is that further taking into consideration the material of the sheet. When a film or a sheet that reflects light is adhered to an area having high transmittance, light is blocked by the film or sheet that reflects light, and the overall transmission of light decreases, causing dimming instead. Therefore, an area in which the film or sheet that reflects light is to be disposed should be decided within a range in which the overall transmission does not decrease.

Therefore, in the present example, as shown in FIG. 4, a film or sheet 30 that reflects light is adhered and disposed on a back surface of the dark brown area of the region 22 of the display panel 16. In the present example, although four strip-shaped films or sheets 30 that reflect light are adhered on the back surface of the dark brown area, this is not limited thereto. For example, a film or sheet 30 that reflects light from which the text 24 has been cut out may be adhered. In addition, in the present example, as shown in FIG. 3, a light reflective body 32 is disposed in the area 28 in which the fluorescent tube 26 is not present in both end sections in the vertical direction within the frame 12. The light reflective body 32 is peak-shaped (v-shaped cross-section) and has a tapered section 34 that becomes closer to the display panel 16, the farther away from the fluorescent tube 26 it is.

Therefore, in the present example, light is reflected by the films or sheets 30 that reflect light, and the light passes through the area of the white text 24. Thus, the text 24 becomes bright.

The materials of the film or sheet 30 that reflects light and the light reflective body 32 are not limited. However, the film or sheet 30 that reflects light and the light reflective body 32 are preferably formed by a thermoplastic resin film or sheet having fine bubbles or pores therewithin, a mean bubble diameter being 50 nm or more and 50 μm or less.

Examples of the material for the above-described thermoplastic resin film or sheet include general-purpose resins such as polyethylene, polypropylene, polystyrene, polyvinyl chloride, polychlorinated biphenyl, polyethylene terephthalate, and polyvinyl alcohol, engineering plastics such as polycarbonate, polybutylene terephthalate, polyethylene naphthalate, polyamide, polyacetal, polyphenylene ether, ultrahigh molecular weight polyethylene, polysulfone, polyethersulfone, polyphenylene sulfide, polyarylate, polyamide-imide, polyetherimide, polyether ether ketone, polyimide, polytetrafluoroethylene, liquid crystal polymer, and fluororesin, and copolymers or mixtures thereof. Among these, polyester, polyphenylene sulfide, polypropylene, and cyclopolyolefin are preferable because of favorable heat resistance, shock resistance, and the like. Additives, such as antioxidants, ultraviolet inhibitors, lubricants, pigments, and reinforcing agents, can be added accordingly to the thermoplastic resin. Furthermore, a coating layer containing such additives may be formed by coating.

More specifically, as an example of the thermoplastic resin film or sheet, a polyester foamed sheet (such as MCPET (registered trademark) manufactured by Furukawa Electric Co., Ltd.) that has an interior bubble diameter of 50 μm or less can be used, the sheet being a thermoplastic polyester extrusion sheet impregnated with carbon dioxide under high pressure, and subsequently heated and foamed. In addition, a cyclopolyolefin foamed sheet similarly having an internal bubble diameter of 50 μm or less can be used.

Another preferred example of the material used to form the film or sheet 30 that reflects light and the light reflective body 32 is a thermoplastic resin film or sheet containing fillers. A film or sheet in which numerous voids are formed with the fillers serving as cores is given as an example. In this instance, in the film or sheet, the thermoplastic resin film or sheet containing the fillers is preferably a porous stretched film or sheet in which numerous voids are formed with the fillers serving as the cores by forming an un-stretched film or sheet containing the fillers and stretching the un-stretched film or sheet.

Various modifications, such as those in (a) to (d), below, are possible in the internal lighting signboard and display panel according to the present embodiment.

(a) The internal lighting signboard may include a box (box-shaped housing) having an opening section on one surface, a display panel that closes the opening section of the box, and a light source installed within the box.

(b) As shown in FIG. 4, a film or sheet 40 that reflects light may be adhered and disposed on a side surface of the display panel.

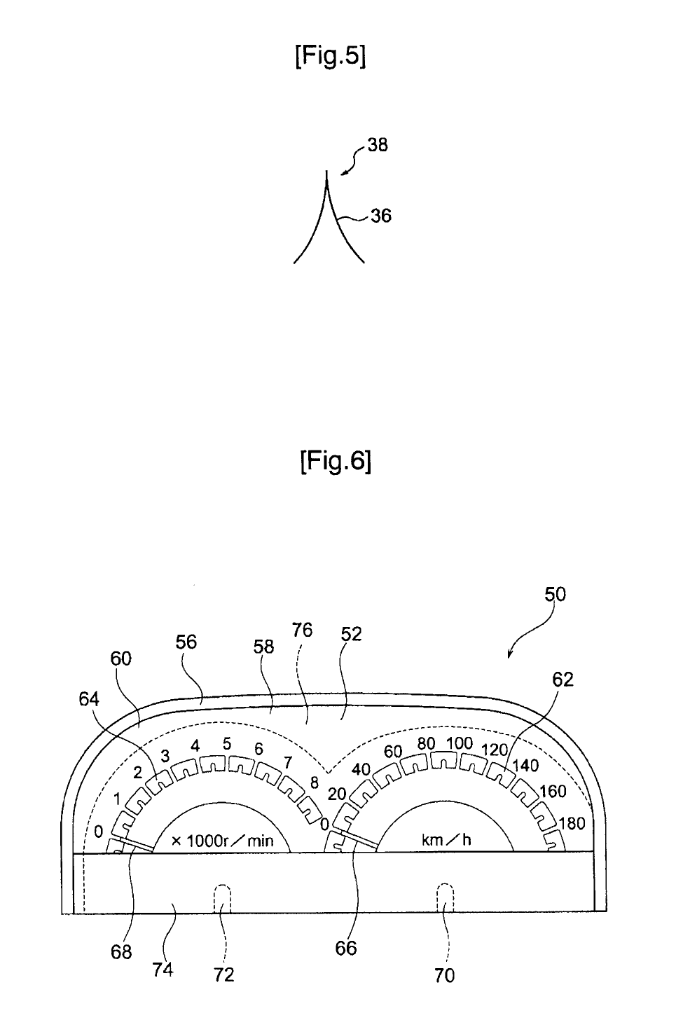

(c) As shown in FIG. 5, a light reflective body may be a peak-shaped light reflective body 38 having a curved surface 36 that becomes closer to the display panel, the farther away from the light source it is. In the light reflective body 38 having the curved surface 36, the text 24 becomes brighter than the light reflective body 32 shown in FIG. 3. However, the light reflective body shown in FIG. 3 is better in terms of facilitation of manufacturing. In addition, the light reflective body may be plate-shaped.

(d) The light reflective body may be provided only in a lower end section in the vertical direction within the frame, or in other words, on the side of the colored area that is the area having low transmittance.

### Second Embodiment

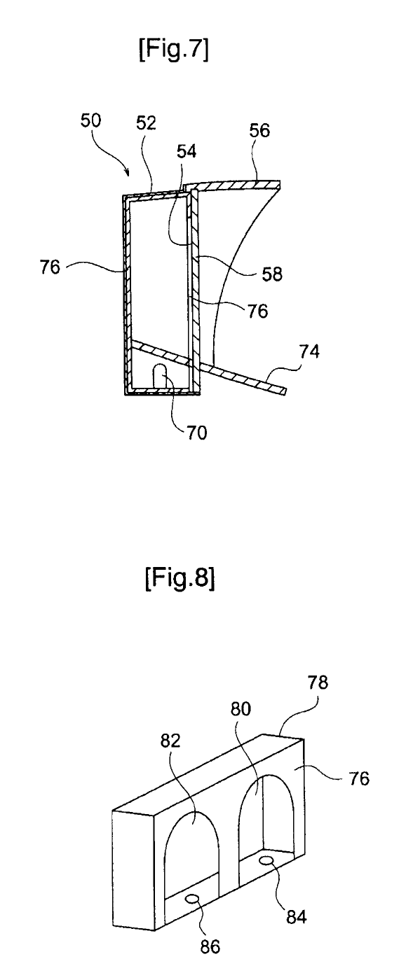

FIG. 6 and FIG. 7 show an internal lighting vehicle display device according to an embodiment of the internal lighting display device of the present invention. FIG. 6 is a schematic front view. FIG. 7 is a schematic cross-sectional view taken along line A-A in FIG. 6.

In a vehicle display device 50 according to the present embodiment, reference number 52 indicates a horizontally long, rectangular box (box-shaped housing) having an opening section 54 on one surface on a front surface side. The box 54 is formed by a synthetic resin. Reference number 56 in the drawings indicates a hood made of synthetic resin that is fixed to the box 52.

The opening section 54 of the box 52 is closed by a display panel 58. The display panel 58 is composed of a synthetic resin board having translucency, such as an acrylic resin, a flexible face (FF) sheet, or polycarbonate. In the present example, a speedometer 62 for displaying the speed of an automobile (vehicle) and a tachometer 64 for displaying engine speed are displayed accordingly in color in a region 60 that is roughly the upper three-fifths. Areas of the region 60 other than the speedometer 62 and the tachometer 64 are transparent. Indicator needles 66 and 68 indicating the speed and engine speed are installed on the inner side of the display panel 58.

Two LEDs 70 and 72 are installed as point-shaped light sources within the box 52, near a movement (not shown) that rotates the indicator needles 66 and 68. The box 52 is provided with a front cover 74 for hiding the LEDs 70 and 72, and the above-described movement.

In the present example, a film or sheet 76 that reflects light is adhered and disposed on a back surface of an area in which the speedometer 62 and the tachometer 63 are not displayed in the region 60 of the display panel 58 (area in which vehicle information is not displayed), and a back surface opposing the display panel 58 of the box 52.

In this instance, in the present example, as shown in FIG. 8, after a rectangular-solid-shaped box 78 is formed by the film or sheet 76 that reflects light, notches 80 and 82 corresponding to the areas of the speedometer 62 and the tachometer 64 and LED insertion holes 84 and 86 are formed in the box 78. The front surface of the box 78 is then adhered to the back surface of the display panel 58. Therefore, in the present example, the film or sheet 76 that reflects light is disposed in the side surface sections, the top surface section, and the bottom surface section of the back surface of the box 52.

Therefore, in the present example, light is reflected by the film or sheet 76 that reflects light, and the light passes through the areas of the speedometer 62 and the tachometer 64. As a result, the areas of the speedometer 62 and the tachometer 64 become bright. In addition, in the present example, because the number of LEDs can be reduced, the demand for energy conservation can be addressed. Furthermore, in the present example, because a display panel that is integrated with a backlight is not required, weight reduction of the display panel and the vehicle display device can be achieved.

The material of the film or sheet 76 that reflects light is similar to that according to the first embodiment. Therefore, description thereof is omitted.

Various modifications, such as (e) and (f), below, are possible in the internal vehicle display device and the display panel according to the present embodiment.

(e) A film or sheet that reflects light may be disposed on a side surface of the display panel.

(f) A film or sheet that reflects light may be disposed only on the back surface of the display panel.

### EXPLANATION OF REFERENCE NUMBERS

10 interior lighting signboard
12 frame
14 opening section
16 display panel
20 text
24 text
26 fluorescent tube (light source)
28 area in which light source is not present
30 film or sheet that reflects light
32 light reflective body
34 tapered section
36 curved surface
38 light reflective body
40 film or sheet that reflects light
50 vehicle display device
52 box (box-shaped housing)
54 opening section
58 display panel
62 speedometer
64 tachometer
70 and 72 LED (light source)
76 film or sheet that reflects light

1-27. (canceled)

28. A display panel of an interior lighting display device comprising:
a frame-shaped housing including an opening section on both surfaces, the display panel that closes both opening sections of the frame-shaped housing; and
a light source installed within the frame-shaped housing,
wherein a film or sheet that reflects light is disposed on a portion or an entirety of a back surface, a side surface, or both.

29. The display panel according to claim 28, wherein the interior lighting display device is an interior lighting signboard.

30. The display panel according to claim 28, wherein the film or sheet that reflects light is disposed on a portion or an entirety of a back surface, a side surface, or both, of a colored area having low transmittance of the display panel.

31. The display panel according to claim 28, wherein the film or sheet that reflects light is disposed on a portion or an entirety of a back surface, a side surface, or both, of an area in which the light source is not present behind the display panel.

32. The display panel according to claim 28, wherein the film or sheet that reflects light is a thermoplastic resin film or sheet having fine bubbles or pores therewithin with a mean bubble diameter of 50 nm or more and 50 μm or less.

33. The display panel according to claim 28, wherein the film or sheet that reflects light is a thermoplastic resin film or sheet containing fillers, and is a film or sheet in which plural voids are formed with the fillers serving as cores.

34. A display panel of an interior lighting display device comprising:
a box-shaped housing including an opening section on one surface, the display panel that closes the opening section of the box-shaped housing; and
a light source installed within the box-shaped housing,
wherein a film or sheet that reflects light is disposed on a portion or an entirety of a back surface, a side surface, or both.

35. The display panel according to claim 34, wherein the interior lighting display device is an interior lighting signboard.

36. The display panel according to claim 34, wherein:
the interior lighting display device is a vehicle display device installed in front of a driver's seat of a vehicle; and
the display panel is a display panel displaying vehicle information, or speed of the vehicle, engine speed, and fuel capacity.

37. The display panel according to claim 34, wherein the film or sheet that reflects light is disposed on a portion or an entirety of a back surface, a side surface, or both, of a colored area having low transmittance of the display panel.

38. The display panel according to claim 34, wherein the film or sheet that reflects light is disposed on a portion or an entirety of a back surface, a side surface, or both, of an area in which the light source is not present behind the display panel.

39. The display panel according to claim 36, wherein the film or sheet that reflects light is disposed on a portion or an entirety of a back surface, a side surface, or both, of an area in which the vehicle information is not displayed of the display panel.

40. The display panel according to claim 34, wherein the film or sheet that reflects light is a thermoplastic resin film or sheet having fine bubbles or pores therewithin with a mean bubble diameter of 50 nm or more and 50 μm or less.

41. The display panel according to claim 34, wherein the film or sheet that reflects light is a thermoplastic resin film or sheet containing fillers, and is a film or sheet in which plural voids are formed with the fillers serving as cores.

42. An interior lighting display device comprising:
a frame-shaped housing having an opening section on both surfaces;
a display panel that closes both opening sections of the frame-shaped housing; and
a light source installed within the frame-shaped housing, wherein
a film or sheet that reflects light is disposed on a portion or an entirety of a back surface, a side surface, or both, of the display panel.

43. The interior lighting display device according to claim 42, wherein the interior lighting display device is an interior lighting signboard.

44. The interior lighting display device according to claim 42, wherein a film or sheet that reflects light is disposed on a portion or an entirety of a back surface opposing the display panel of the box-shaped housing.

45. The interior lighting display device according to claim 42, wherein the film or sheet that reflects light is disposed on a portion or an entirety of a back surface, a side surface, or both, of a colored area having low transmittance of the display panel.

46. The interior lighting display device according to claim 42, wherein the film or sheet that reflects light is disposed on a portion or an entirety of a back surface, a side surface, or both, of an area in which the light source is not present behind the display panel.

47. The interior lighting display device according to claim 42, wherein the film or sheet that reflects light is a thermoplastic resin film or sheet having fine bubbles or pores therewithin with a mean bubble diameter of 50 nm or more and 50 μm or less.

48. The interior lighting display device according to claim 42, wherein the film or sheet that reflects light is a thermoplastic resin film or sheet containing fillers, and is a film or sheet in which plural voids are formed with the fillers serving as cores.

49. An interior lighting display device comprising:
a box-shaped housing having an opening section on one surface;
a display panel that closes the opening section of the box-shaped housing; and
a light source installed within the box-shaped housing, wherein
a film or sheet that reflects light is disposed on a portion or an entirety of a back surface, a side surface, or both.

50. The interior lighting display device according to claim 49, wherein the interior lighting display device is an interior lighting signboard.

51. The interior lighting display device according to claim 49, wherein:
the interior lighting display device is a vehicle display device installed in front of a driver's seat of a vehicle; and
the display panel is a display panel displaying vehicle information, or speed of the vehicle, engine speed, and fuel capacity.

52. The interior lighting display device according to claim 49, wherein a film or sheet that reflects light is disposed on a portion or an entirety of a back surface opposing the display panel of the box-shaped housing.

53. The interior lighting display device according to claim 49, wherein the film or sheet that reflects light is disposed on a portion or an entirety of a back surface, a side surface, or both, of a colored area having low transmittance of the display panel.

54. The interior lighting display device according to claim 49, wherein the film or sheet that reflects light is disposed on a portion or an entirety of a back surface, a side surface, or both, of an area in which the light source is not present behind the display panel.

55. The interior lighting display device according to claim 51, wherein the film or sheet that reflects light is disposed on a portion or an entirety of a back surface, a side surface, or both, of an area in which the vehicle information is not displayed of the display panel.

56. The interior lighting display device according to claim 49, wherein the film or sheet that reflects light is a thermoplastic resin film or sheet having fine bubbles or pores therewithin with a mean bubble diameter of 50 nm or more and 50 μm or less.

57. The interior lighting display device according to claim 49, wherein the film or sheet that reflects light is a thermoplastic resin film or sheet containing fillers, and is a film or sheet in which plural voids are formed with the fillers serving as cores.

58. An interior lighting display device comprising:
a frame-shaped housing having an opening section on both surfaces;
a display panel that closes both opening sections of the frame-shaped housing; and
a light source installed within the frame-shaped housing, wherein
a light reflective body is disposed in an area in which the light source is not present within the frame-shaped housing.

59. The interior lighting display device according to claim 58, wherein the light reflective body is peak-shaped, and has a tapered section that becomes closer to the display panel, the farther away from the light source the light reflective body is.

60. The interior lighting display device according to claim 58, wherein the light reflective body is peak-shaped, and has a curved surface that becomes closer to the display panel, the farther away from the light source the light reflective body is.

61. The interior lighting display device according to claim 58, wherein the light reflective body is formed by a film or sheet that reflects light.

62. The interior lighting display device according to claim 61, wherein the film or sheet that reflects light is a thermoplastic resin film or sheet having fine bubbles or pores therewithin with a mean bubble diameter of 50 nm or more and 50 μm or less.

63. The interior lighting display device according to claim 61, wherein the film or sheet that reflects light is a thermoplastic resin film or sheet containing fillers, and is a film or sheet in which plural voids are formed with the fillers serving as cores.

64. An interior lighting display device comprising:
a box-shaped housing having an opening section on one surface;
a display panel that closes the opening section of the box-shaped housing; and
a light source installed within the box-shaped housing, wherein
a light reflective body is disposed in an area in which the light source is not present within the box-shaped housing.

65. The interior lighting display device according to claim 64, wherein the light reflective body is peak-shaped, and has a tapered section that becomes closer to the display panel, the farther away from the light source the light reflective body is.

66. The interior lighting display device according to claim 64, wherein the light reflective body is peak-shaped, and has a curved surface that becomes closer to the display panel, the farther away from the light source the light reflective body is.

67. The interior lighting display device according to claim 64, wherein the light reflective body is formed by a film or sheet that reflects light.

68. The interior lighting display device according to claim 67, wherein the film or sheet that reflects light is a thermoplastic resin film or sheet having fine bubbles or pores therewithin with a mean bubble diameter of 50 nm or more and 50 μm or less.

69. The interior lighting display device according to claim 67, wherein the film or sheet that reflects light is a thermoplastic resin film or sheet containing fillers, and is a film or sheet in which plural voids are formed with the fillers serving as cores.
